(19) United States
(12) Patent Application Publication
(10) Pub. No.: US 2008/0237243 A1
(43) Pub. Date: Oct. 2, 2008

(54) Nano energy cup

(76) Inventor: Li Chi Hong, Hong Kong (CN)

Correspondence Address: DAVID AND RAYMOND PATENT FIRM, 108 N. YNEZ AVE., SUITE 128, MONTEREY PARK, CA, 91754, US

(21) Appl. No.: 11/645,782

(22) Filed: Mar. 29, 2007

(51) Int. Cl. A47J 41/00

(52) U.S. Cl. 220/592.17

(57) ABSTRACT

A kind of energy cup possesses the heat resistant and heat preserving effects and consists of energy nano material in the cup body and cover. The cup body is constituted by the inner cup body and outer cup body. There is an empty layer between the inner and outer cup bodies. The whole external surface of the inner cup body is stuck with a layer of nano material. A layer of heat resistant material is placed between the nano material layer and the internal surface of the outer cup body, so the empty layer between the inner and outer cup body is filled with the nano material layer and the heat resistant material layer. The benefit is the saving of lot of raw nano material, thus the production cost can be reduced. As there is heat resistant material between the outer cup body and the nano material layer, the heat inside the cup body will not easily be dispersed; therefore the heat preserving effect is strengthened. This model can be widely used in thermal containers including cups, heat preservation cups, thermos and hot-water flask etc.

### BACKGROUND OF THE PRESENT INVENTION

1. Field of Invention

The present invention is a practical new model involving a kind of cup (including thermal containers like heat preservation cups, thermos and hot-water flask etc) especially the kind of energy cup that possesses the heat resistant as well as heat preserving effects and consists of energy nano material.

2. Description of Related Arts

In order to cope with the need in healthcare in modern life, some manufacturers produce and develop various kinds of nano cups. These nano cups are normally made by pouring nano material in the middle layer of the cup bodies. Nano cups of this constitution though improve the water quality in the cup to a certain extent; there are still some drawbacks in it. For example, filling the empty layer with nano material which is rather expensive, the cost of cups will increase. Another thing is, as the nano material is staying between the inner and outer cup bodies, the inner cup body will transmit the heat fast and the time for preserving heat will be short, and the fast heat transmission will heat the outer cup body and make it hot to touch. As the heat resistance is poor the cup body has to be cooled before it can be held.

### SUMMARY OF THE PRESENT INVENTION

The objective of this practical new model is to overcome the above mentioned drawbacks in the existing technology and provide a nano cup that will reduce the nano material used and have good heat preserving effect, good strength in enhancing energy and be able to improve human health.

In order to achieve the above objectives, the technical solution adopted in this practical new model is: A kind of nano energy cup including the cup body and cup cover. The cup body is constituted by the inner cup body and outer cup body, and there is an empty layer between the inner and outer cup bodies. On the whole external surface of the above mentioned inner cup body is stuck with a layer of nano material, and a layer of heat resistant material is placed between the nano material layer and the internal surface of the outer cup body.

The beneficial effect of this practical new model is that it consists of only a layer of nano material stuck to the external surface of the inner cup body, in comparing with the ones with nano material filling the whole middle layer, this model saves a lot of nano material used, as well as producing a consistent effect, thus the production cost of nano cup can be reduced. As there is a heat resistant material between the nano material layer and the outer cup body, the heat inside the cup will not be dispersed easily, thus the heat preserving strength is enhanced. In addition, as the heat transmitted through the inner cup body will be obstructed by the heat resistant material layer, the outer cup body will not be heated, thus the cup can be held for drinking directly under the good heat resistant effect. Nano also has the functions of activating the clusters of water molecules and cause them to become smaller, thus the oxygen content and energy can be increased. Inspection showed that this practical new model energy cup can obviously reduce the hazardous substances in water, and this will help the absorption and penetration functions of human body which is very beneficial to health. This practical new structure can be widely used in thermal containers including cups, heat preservation cups, thermos and hot-water flask etc.

### BRIEF DESCRIPTION OF DRAWINGS

FIG. 1 is the sectional view of the present invention according to the preferred embodiment.

### DETAILED DESCRIPTION OF THE PREFERRED EMBODIMENT

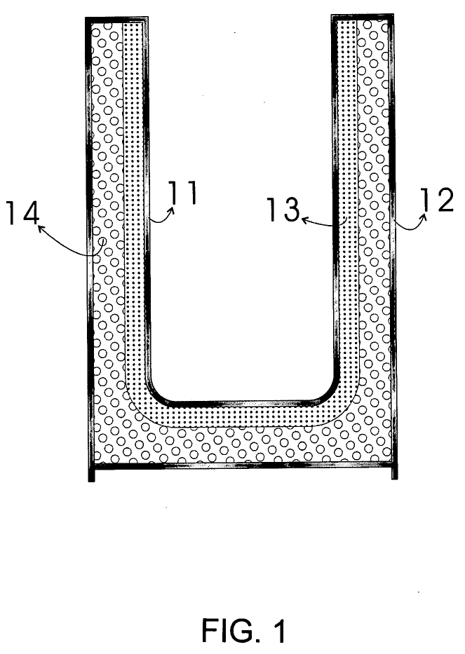

The following is further elaboration of the comprehensive implementation method in connection with the picture description. This practical new model includes the cup body and cup cover. The cup cover can make use of the existing structure to form a set with the cup body, so we will not further elaborate it. As illustrated in FIG. 1, the cup body is constituted of inner cup body (11) and outer cup body (12), and there is an empty layer between the inner and outer bodies (11,12). On the whole external surface of inner cup body (11) is coated with a nano material layer (13). Between the nano material layer (13) and the internal surface of outer cup body (12) is a layer of heat resistant layer (14). The whole empty layer is filled with nano material layer (13) and the heat resistant material layer (14). The cup body of this practical new model can be made of stainless steel, plastic and ceramic etc. materials. Cup cover is made with the same material as the cup body. The nano material layer of this practical new model can be composed of the main components of Ba, Mg, Sio2 and Zno etc. After the dispersant treatment, the material will be mixed with adhesives, and pasted on the external surface of inner cup body (11) so as to firmly stick to the external surface of the inner cup body (11). The heat resistant layer can be made of various kinds of heat resistant materials. Then continue to produce the end product of the nano cup by applying the familiar technical flow in the industry. The cup then can be used.

What is claimed is:

1. A kind of nano energy cup including a cup body and cup cover, wherein the cup body comprises an inner cup body and an outer cup body, and there is an empty layer between said inner and said outer cup body, wherein the whole external surface of said inner cup body is stuck with a layer of nano material, and a layer of heat resistant material is placed between said nano material layer and said internal surface of said outer cup body, so the empty layer between said inner and said outer cup bodies is filled with said nano material layer and said resistant material layer.
